(19) United States
(12) Patent Application Publication
(10) Pub. No.: US 2010/0101376 A1
(43) Pub. Date: Apr. 29, 2010

(54) Ratchet Open End Wrench

(76) Inventor: Chen-Tsung Chen, Jiali Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/257,606

(22) Filed: Oct. 24, 2008

(51) Int. Cl. B25B 13/46; B25B 13/08

(52) U.S. Cl. 81/60; 81/176.2

(57) ABSTRACT

A ratchet open end wrench includes a wrench body provided with an operation head, a ratchet unit mounted on the operation head, and at least one drive unit mounted on the wrench body and engaged with the ratchet unit. The ratchet unit includes a ratchet member provided with a plurality of oneway ratchet teeth. The drive unit includes a pawl member provided with a plurality of oneway driving teeth engaged with the oneway ratchet teeth. Thus, the ratchet member is driven by the pawl member to rotate a workpiece, so that the reaction force applied by the workpiece onto the operation head is shared by and distributed on the drive unit and the wrench body to prevent the force from being concentrated on the operation head.

### BACKGROUND OF THE INVENTION

1. Field of the Invention

The present invention relates to a wrench and, more particularly, to a ratchet open end wrench.

2. Description of the Related Art

A conventional open end wrench comprises a wrench body having two opposite ends each provided with a substantially C-shaped operation head. Thus, the operation head of the wrench body is mounted on a workpiece, such as a hexagonal nut, bolt and the like, so as to operate and rotate the workpiece by rotation of the wrench body. However, the operation head of the wrench body cannot rotate the workpiece successively, so that a user has to mount the operation head of the wrench body on the workpiece and to remove the operation head of the wrench body from the workpiece in an alternating manner, thereby causing inconvenience to the user when operating the operation head of the wrench body to rotate the workpiece.

### BRIEF SUMMARY OF THE INVENTION

In accordance with the present invention, there is provided a ratchet open end wrench, comprising a wrench body provided with an open operation head, a ratchet unit mounted on the operation head of the wrench body, and at least one drive unit mounted on the wrench body and engaged with the ratchet unit to drive the ratchet unit to rotate in a oneway direction by rotation of the operation head of the wrench body relative to the ratchet unit. The ratchet unit includes a ratchet member mounted in the operation head of the wrench body and having an outer wall provided with a plurality of oneway ratchet teeth. The drive unit includes a pawl member provided with a plurality of oneway driving teeth engaged with the oneway ratchet teeth of the ratchet member. The ratchet unit further includes a retaining member located between the ratchet member and the operation head of the wrench body to retain the ratchet member in the operation head of the wrench body. The drive unit further includes a fastening member secured on the wrench body and an elastic member biased between the pawl member and the fastening member to push the pawl member toward the ratchet member of the ratchet unit and to push the oneway driving teeth of the pawl member toward the oneway ratchet teeth of the ratchet member.

The primary objective of the present invention is to provide a ratchet open end wrench that is used to operate a workpiece in a oneway direction so that a user can operate the ratchet open end wrench in an energy-saving manner.

Another objective of the present invention is to provide a ratchet open end wrench, wherein the ratchet member of the ratchet unit is driven by the pawl member of the drive unit to rotate the workpiece, so that the reaction force applied by the workpiece onto the operation head of the wrench body is shared by and distributed on the drive unit and the wrench body to prevent the force from being concentrated on the operation head of the wrench body and to prevent the operation head of the wrench body from being distorted or deformed due to a stress concentration so as to enhance the lifetime of the operation head of the wrench body.

A further objective of the present invention is to provide a ratchet open end wrench, wherein the retaining member of the ratchet unit is a substantially C-shaped snap ring so that the retaining member of the ratchet unit is deformed when the ratchet unit is inserted into the receiving chamber of the operation head, thereby facilitating assembly of the ratchet unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a ratchet open end wrench in accordance with the preferred embodiment of the present invention.

FIG. 2 is an exploded perspective view of the ratchet open end wrench as shown in FIG. 1.

FIG. 3 is a top cross-sectional view of the ratchet open end wrench as shown in FIG. 1.

FIG. 4 is a cross-sectional view of the ratchet open end wrench taken along line 4-4 as shown in FIG. 3.

FIG. 5 is a schematic operational view of the ratchet open end wrench as shown in FIG. 3 in use.

FIG. 6 is a locally enlarged cross-sectional view of the ratchet open end wrench as shown in FIG. 5.

FIG. 7 is a top view of a ratchet open end wrench in accordance with another preferred embodiment of the present invention.

### DETAILED DESCRIPTION OF THE INVENTION

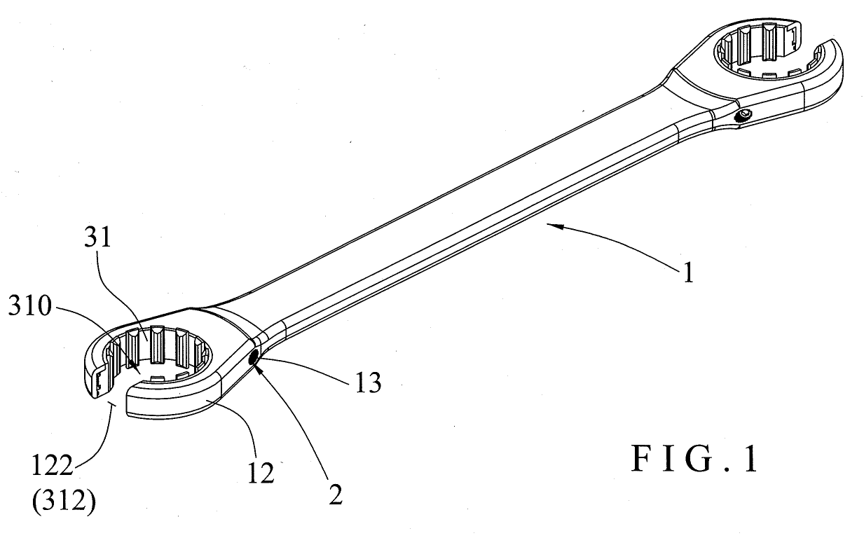

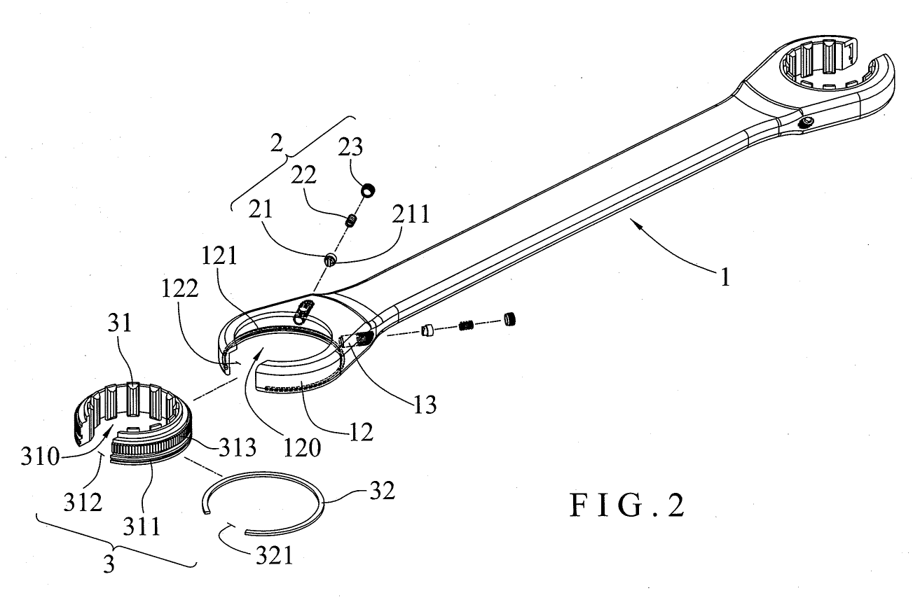

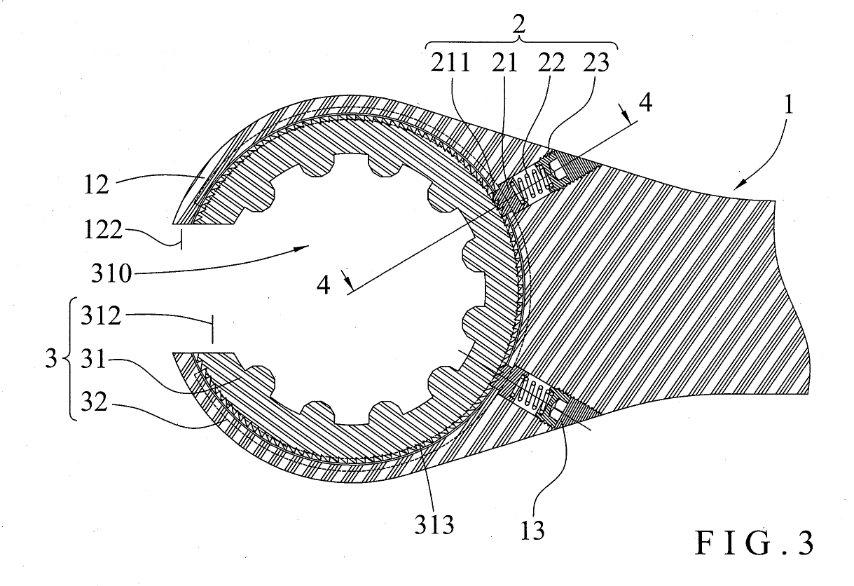

Referring to the drawings and initially to FIGS. 1-6, a ratchet open end wrench in accordance with the preferred embodiment of the present invention comprises a wrench body 1 provided with an open operation head 12, a ratchet unit 3 mounted on the operation head 12 of the wrench body 1, and at least one drive unit 2 mounted on the wrench body 1 and engaged with the ratchet unit 3 to drive the ratchet unit 3 to rotate in a oneway direction by rotation of the operation head 12 of the wrench body 1 relative to the ratchet unit 3.

The operation head 12 of the wrench body 1 has a substantially C-shaped profile. The operation head 12 of the wrench body 1 has an inner portion provided with a receiving chamber 120 to receive the ratchet unit 3 and has a side provided with an opening 122 connected to the receiving chamber 120. The receiving chamber 120 of the operation head 12 has a peripheral wall provided with a retaining groove 121 connected to the receiving chamber 120. The wrench body 1 has a side provided with at least one mounting hole 13 connected to the receiving chamber 120 to receive the at least one drive unit 2. The mounting hole 13 of the wrench body 1 is located at a connection of the operation head 12 and the wrench body 1. Preferably, the wrench body 1 is provided with two mounting holes 13. The two mounting holes 13 of the wrench body 1 are inclined relative to each other, and an acute angle is defined between the two mounting holes 13 of the wrench body 1.

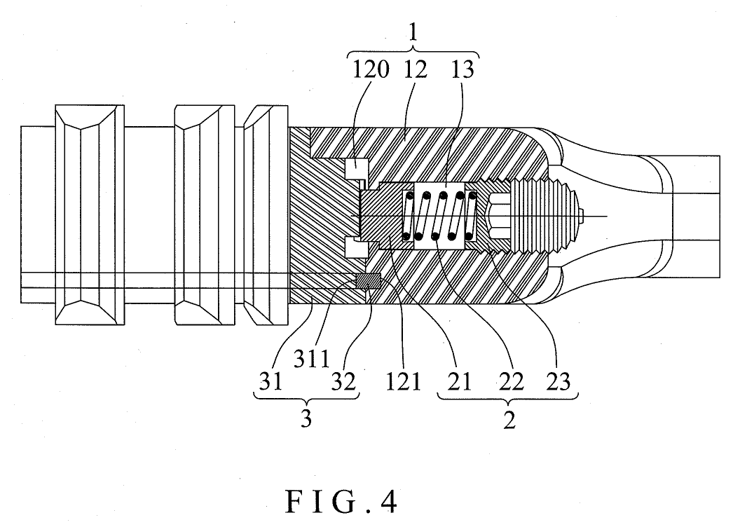

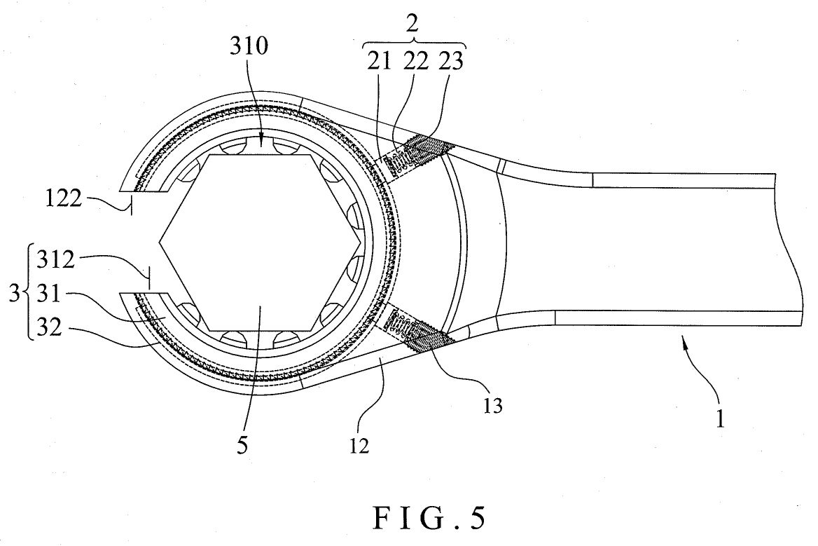

The ratchet unit 3 includes a ratchet member 31 mounted in the operation head 12 of the wrench body 1 and having an outer wall provided with a plurality of oneway ratchet teeth 313, and a retaining member 32 located between the ratchet member 31 and the operation head 12 of the wrench body 1 to retain the ratchet member 31 in the operation head 12 of the wrench body 1. The ratchet member 31 of the ratchet unit 3 is mounted in the receiving chamber 120 of the operation head 12. The ratchet member 31 of the ratchet unit 3 has a substantially C-shaped profile. The ratchet member 31 of the ratchet unit 3 has an inner wall provided with an operation hole 310 to receive a workpiece 5 (see FIG. 5), such as a hexagonal nut, bolt and the like, and has a side provided with a breach 312 connected to the operation hole 310 and the opening 122 of the operation head 12 to allow passage of the workpiece 5. The outer wall of the ratchet member 31 is provided with a retaining slot 311 located under the oneway ratchet teeth 313 to receive the retaining member 32. The retaining member 32 of the ratchet unit 3 is a substantially C-shaped snap ring and has an inner portion retained in the retaining slot 311 of the ratchet member 31 and an outer portion retained in the retaining groove 121 of the operation head 12 as shown in FIG. 4. The retaining member 32 of the ratchet unit 3 has a side provided with a cutout 321.

The drive unit 2 includes a pawl member 21 provided with a plurality of oneway driving teeth 211 engaged with the oneway ratchet teeth 313 of the ratchet member 31, a fastening member 23 secured on the wrench body 1, and an elastic member 22 biased between the pawl member 21 and the fastening member 23 to push the pawl member 21 toward the ratchet member 31 of the ratchet unit 3 and to push the oneway driving teeth 211 of the pawl member 21 toward the oneway ratchet teeth 313 of the ratchet member 31. The pawl member 21 of the drive unit 2 is movably mounted in the mounting hole 13 of the wrench body 1. The fastening member 23 of the drive unit 2 is secured in the mounting hole 13 of the wrench body 1.

In the preferred embodiment of the present invention, the ratchet open end wrench comprises two drive units 2 mounted in the two mounting holes 13 of the wrench body 1 respectively. Preferably, the two drive units 2 are inclined relative to each other, and an acute angle is defined between the two drive units 2. The drive units 2 are located symmetrically at two opposite sides of the operation head 12 of the wrench body 1.

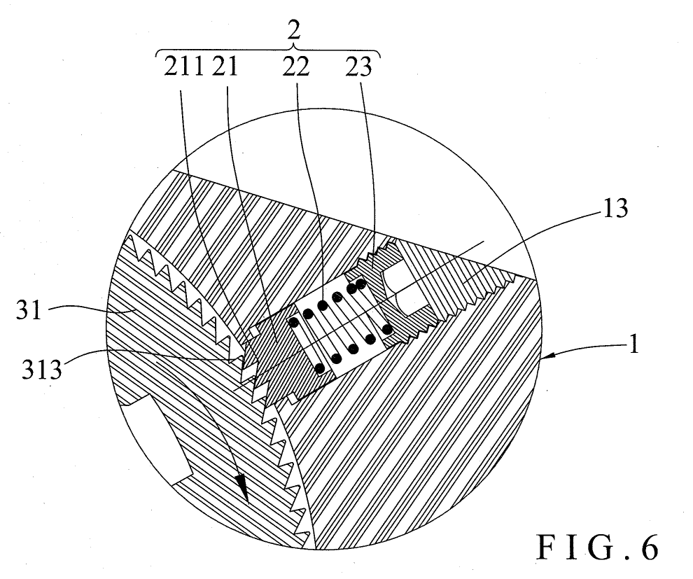

In operation, referring to FIGS. 5 and 6 with reference to FIGS. 1-4, the workpiece 5 is initially secured in the operation hole 310 of the ratchet member 31. Then, the wrench body 1 is rotated to drive the drive unit 2. At this time, the oneway driving teeth 211 of the pawl member 21 engage the oneway ratchet teeth 313 of the ratchet member 31 in a oneway manner, so that the pawl member 21 of the drive unit 2 drives the ratchet member 31 of the ratchet unit 3 to rotate the workpiece 5 in a oneway direction. In such a manner, the ratchet member 31 of the ratchet unit 3 is driven by the pawl member 21 of the drive unit 2 to rotate the workpiece 5, so that the reaction force applied by the workpiece 5 onto the operation head 12 of the wrench body 1 is shared by and distributed on the drive unit 2 and the wrench body 1 to prevent the force from being concentrated on the operation head 12 of the wrench body 1 and to prevent the operation head 12 of the wrench body 1 from being distorted or deformed due to a stress concentration so as to enhance the lifetime of the operation head 12 of the wrench body 1.

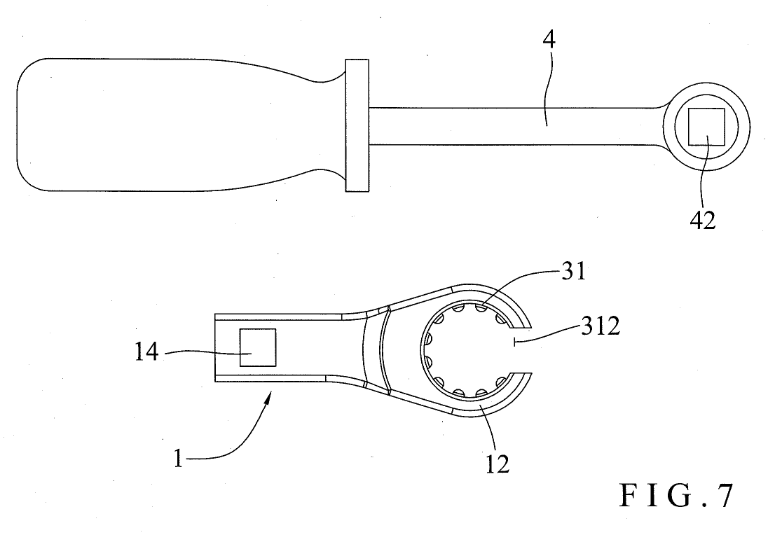

As shown in FIG. 7, the wrench body 1 has a surface provided with a driving hole 14 to allow insertion of a drive stud 42 of a ratchet tool 4, so that the wrench body 1 is driven by the drive stud 42 of the ratchet tool 4 to rotate the operation head 12.

Accordingly, the ratchet member 31 of the ratchet unit 3 is driven by the pawl member 21 of the drive unit 2 to rotate the workpiece 5, so that the reaction force applied by the workpiece 5 onto the operation head 12 of the wrench body 1 is shared by and distributed on the drive unit 2 and the wrench body 1 to prevent the force from being concentrated on the operation head 12 of the wrench body 1 and to prevent the operation head 12 of the wrench body 1 from being distorted or deformed due to a stress concentration so as to enhance the lifetime of the operation head 12 of the wrench body 1. In addition, the retaining member 32 of the ratchet unit 3 is a substantially C-shaped snap ring so that the retaining member 32 of the ratchet unit 3 is deformed when the ratchet unit 3 is inserted into the receiving chamber 120 of the operation head 12, thereby facilitating assembly of the ratchet unit 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A ratchet open end wrench, comprising:
a wrench body provided with an open operation head;
a ratchet unit mounted on the operation head of the wrench body;
at least one drive unit mounted on the wrench body and engaged with the ratchet unit to drive the ratchet unit to rotate in a oneway direction by rotation of the operation head of the wrench body relative to the ratchet unit.

2. The ratchet open end wrench of claim 1, wherein
the ratchet unit includes a ratchet member mounted in the operation head of the wrench body and having an outer wall provided with a plurality of oneway ratchet teeth;
the drive unit includes a pawl member provided with a plurality of oneway driving teeth engaged with the oneway ratchet teeth of the ratchet member.

3. The ratchet open end wrench of claim 2, wherein the ratchet unit further includes:
a retaining member located between the ratchet member and the operation head of the wrench body to retain the ratchet member in the operation head of the wrench body.

4. The ratchet open end wrench of claim 3, wherein the drive unit further includes:
a fastening member secured on the wrench body;
an elastic member biased between the pawl member and the fastening member to push the pawl member toward the ratchet member of the ratchet unit and to push the oneway driving teeth of the pawl member toward the oneway ratchet teeth of the ratchet member.

5. The ratchet open end wrench of claim 4, wherein the operation head of the wrench body has an inner portion provided with a receiving chamber to receive the ratchet unit.

6. The ratchet open end wrench of claim 5, wherein
the receiving chamber of the operation head has a peripheral wall provided with a retaining groove connected to the receiving chamber to receive the retaining member;
the outer wall of the ratchet member is provided with a retaining slot to receive the retaining member;
the retaining member of the ratchet unit has an inner portion retained in the retaining slot of the ratchet member and an outer portion retained in the retaining groove of the operation head.

7. The ratchet open end wrench of claim 5, wherein the wrench body has a side provided with at least one mounting hole connected to the receiving chamber to receive the at least one drive unit.

8. The ratchet open end wrench of claim 7, wherein the mounting hole of the wrench body is located at a connection of the operation head and the wrench body.

9. The ratchet open end wrench of claim 7, wherein
the wrench body is provided with two mounting holes;
the ratchet open end wrench comprises two drive units mounted in the two mounting holes of the wrench body respectively.

10. The ratchet open end wrench of claim 9, wherein
the two mounting holes of the wrench body are inclined relative to each other;
an acute angle is defined between the two mounting holes of the wrench body.

11. The ratchet open end wrench of claim 9, wherein
the two drive units are inclined relative to each other;
an acute angle is defined between the two drive units.

12. The ratchet open end wrench of claim 9, wherein the drive units are located symmetrically at two opposite sides of the operation head of the wrench body.

13. The ratchet open end wrench of claim 6, wherein the retaining slot of the ratchet member is located under the oneway ratchet teeth.

14. The ratchet open end wrench of claim 5, wherein the ratchet member of the ratchet unit is mounted in the receiving chamber of the operation head.

15. The ratchet open end wrench of claim 7, wherein the pawl member of the drive unit is movably mounted in the mounting hole of the wrench body.

16. The ratchet open end wrench of claim 7, wherein the fastening member of the drive unit is secured in the mounting hole of the wrench body.

17. The ratchet open end wrench of claim 5, wherein the ratchet member of the ratchet unit has an inner wall provided with an operation hole.

18. The ratchet open end wrench of claim 17, wherein
the operation head of the wrench body has a side provided with an opening connected to the receiving chamber;
the ratchet member of the ratchet unit has a side provided with a breach connected to the operation hole and the opening of the operation head.

19. The ratchet open end wrench of claim 3, wherein the retaining member of the ratchet unit is a substantially C-shaped snap ring and has a side provided with a cutout.

20. The ratchet open end wrench of claim 1, wherein
the operation head of the wrench body has a substantially C-shaped profile;
the ratchet member of the ratchet unit has a substantially C-shaped profile.
